(19) United States
(12) Patent Application Publication
(10) Pub. No.: US 2006/0250086 A1
(43) Pub. Date: Nov. 9, 2006

(54) Vacuum Getter Chamber

(76) Inventor: Frank Yang, Guanyin Township (TW)

Correspondence Address: HDSL, 4331 STEVENS BATTLE LANE, FAIRFAX, VA, 22033, US

(21) Appl. No.: 11/458,386

(22) Filed: Jul. 18, 2006

Related U.S. Application Data
(63) Continuation-in-part of application No. 10/892,218, filed on Jul. 16, 2004, now abandoned.

(51) Int. Cl. H01J 61/26

(52) U.S. Cl. 313/561

(57) ABSTRACT

A vacuum getter structure is used for a flat panel display. A panel of the display has an anode plate and a cathode plate forming a vacuum space therebetween. The cathode plate includes two apertures formed on a non-display effective area located at edges thereof to extend therethough. The getters are distributed along two edges of the cathode plate between the two apertures. The vacuum getter structure includes a U-shaped frame recessed upwardly from a bottom surface to form a continuous getter chamber and a hole in communication with the getter chamber, the U-shaped frame being attached to the cathode plate to cover the two apertures and all the getters in the getter chamber. A thickness of the U-shaped frame plus a depth of the getter chamber are no less than a factor 0.75 of a thickness of the panel so that it will make the panel have over 5 times of elasticity than conventional panel.

### RELATED APPLICATIONS

This application is a continuation-in-part of U.S. patent application Ser. No. 10/892,218, filed on Jul. 16, 2004.

### BACKGROUND OF THE INVENTION

The present invention relates in general to a structure of a vacuum getter structure, and more particularly, to a flat panel display having a vacuum getter structure to provide a sufficient vacuum level during vacuuming process, as well as contiguous support to the rectangular panel on width and length directions so that the panel can have effective elasticity against bending or other deformations.

The conventional vacuum display such as the vacuum fluorescent display (VFD) as disclosed in U.S. Pat. No. 5,635,795, cathode ray tube (CRT), field-emission display (FED) as disclosed in U.S. Pat. No. 6,084,344 provides a vacuum cathode in which a free path is formed allowing an electron beam generated from a cathode electrode to propagate, so as to impinge the phosphor of an anode electrode to generate light.

The vacuum level of the above vacuum display is typically kept at 10⁻⁵ to 10⁻⁷ torr. Although the vacuum level of cavity can be maintained by packaging the cavity, leakage is still unavoidable. The source of the leakage includes the package material, the internal material of the vacuum device such as the coating of the cathode and anode electrodes, electron-emission source, and phosphor, for example. The leakage source during operation includes the heat of phosphor excited by the electron beam. Such type of leakage may even poison the material of the electron-emission source or the phosphor to affect the luminescent efficiency.

Therefore, to maintain the vacuum level of the cavity, a getter box has been installed in the vacuum chamber, and a getter is disposed in the vacuum chamber. The getter is normally composed of barium compound. By activation process, pure barium can be released to attach to a large area of the getter chamber, such that the leakage can be absorbed by the pure barium effectively.

The activation process for barium has to be performed at a temperature higher than 700° C., and the barium has to be disposed at a specific area. Therefore, to avoid affecting or activating other members such as the electron-emission source or the phosphor, the barium is located at a place remote to the effective display area. As a result, the ineffective area of the display is increased; and consequently, the available display area is reduced.

### BRIEF SUMMARY OF THE INVENTION

Brand new vacuum getter structure and getters are provided to provide gas guide, so as to reduce vacuuming time, cost and the total thickness. Therefore, the overall thickness of the display can be minimized, and the insufficient vacuum level at the corner of the flat-panel structure can also be resolved. Further, the vacuum getter structure can be used as a reinforcing rib of the display, such that the strength of the cathode panel structure is increased. This is advantageous in fabricating a large-area flat panel display. Further, the glass cracking problem caused by local high temperature during the tip-off process can be overcome. In addition, the locations for disposing the getter are reduced to increase vacuum level. As the activation temperature of the getter is relatively lower, the internal materials of the display will not be affected by the activation process. Therefore, the ineffective display area is reduced.

Accordingly, a flat panel display provided by the present invention includes a panel, getters and a vacuum getter structure. The panel has an anode plate and a cathode plate forming a vacuum space therebetween. The cathode plate includes two apertures formed on a non-display effective area located at edges thereof to extend therethough. The getters are distributed along two edges of the cathode plate between the two apertures. The vacuum getter structure includes a U-shaped frame recessed upwardly from a bottom surface to form a continuous getter chamber and a hole in communication with the getter chamber, the U-shaped frame being attached to the cathode plate to cover the two apertures and all the getters in the getter chamber. A thickness of the U-shaped frame plus a depth of the getter chamber are no less than a factor 0.75 of a thickness of the panel.

### BRIEF DESCRIPTION OF THE DRAWINGS

The above objects and advantages of the present invention will be become more apparent by describing in detail exemplary embodiments thereof with reference to the attached drawings in which:

FIG. 1 is perspective view of a vacuum getter structure;

FIG. 2 is a side view of the vacuum getter structure;

FIG. 3 shows the application of the vacuum getter structure to a panel of a flat panel display;

FIG. 4 illustrates assembly of the vacuum getter structure and the panel of the flat panel display;

FIG. 5 shows a cross sectional view along line 5-5 of FIG. 4; and

FIG. 6 shows a locally enlarged view of FIG. 5.

### DETAILED DESCRIPTION OF THE INVENTION

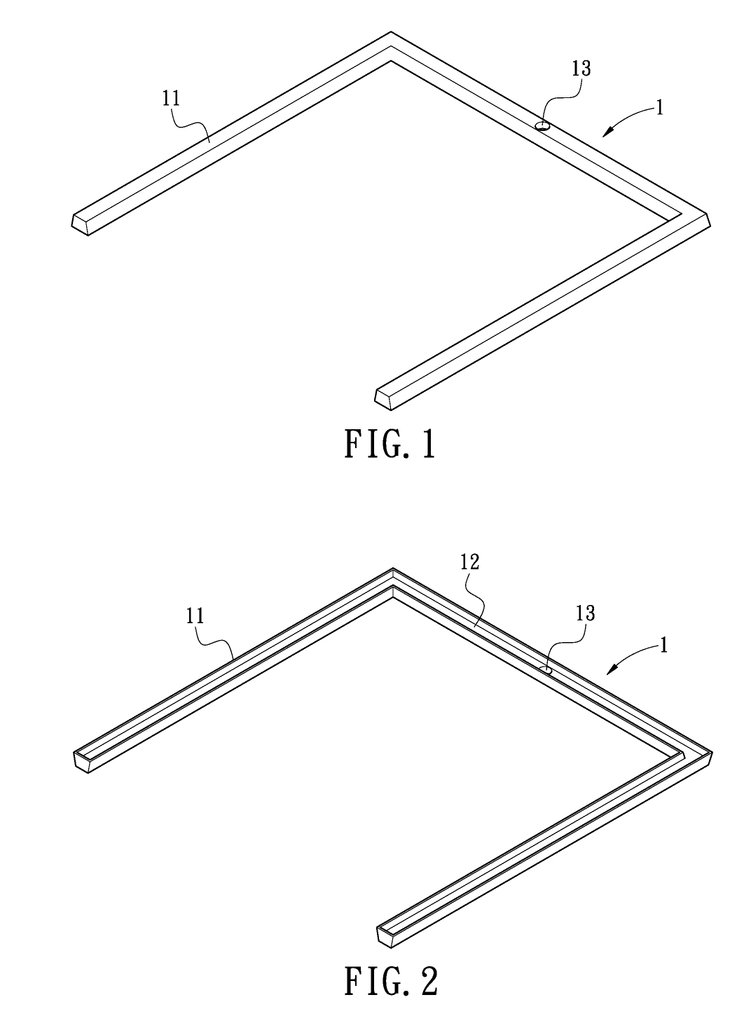

Referring to FIGS. 1 and 2, as provided, the vacuum getter structure is applied to a panel of a flat panel display such as a field-emission display to provide a vacuum getter structure, in which a free path is established after vacuuming process. Therefore, an electron beam generated by the cathode electrode of the panel can propagate along the free path to impinge the phosphor of the anode electrode. The vacuum getter structure 1 of the present invention is a continuously U-shaped frame 11 which is not only for providing vacuum effect but also providing contiguous support to rectangular panel on width and length directions so that the panel can have effective elasticity against bending or other deformations.

The vacuum getter structure 1 is formed by thermal pressing a flat panel glass or using glass paste ejection to obtain the continuously U-shaped frame 11 recessed upwardly from bottom surface to form a continuous getter chamber 12 and with a hole 13 in communication with the getter chamber 12.

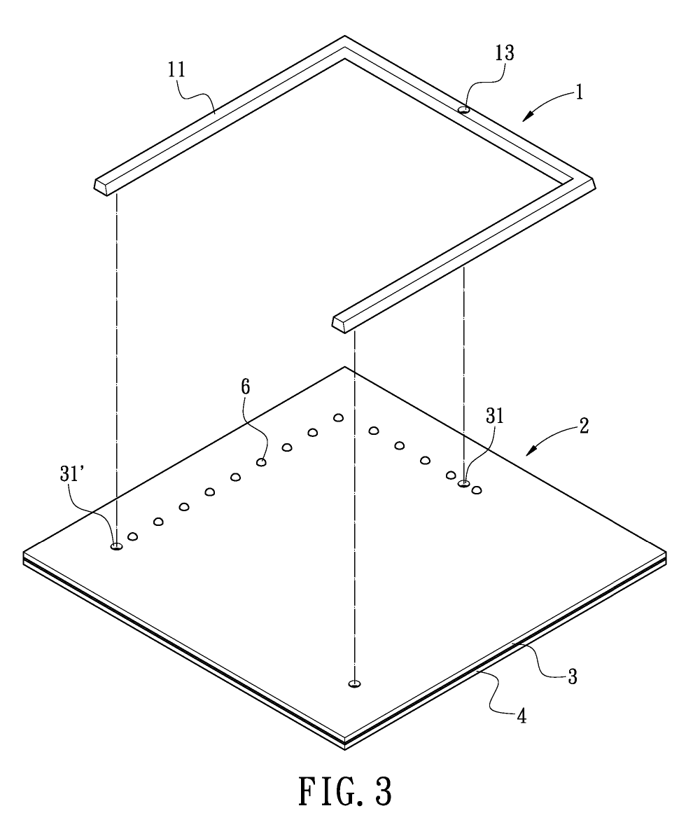

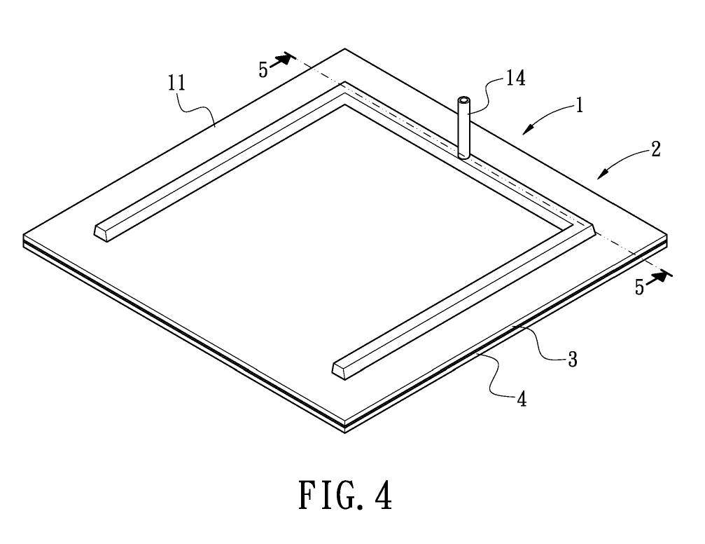

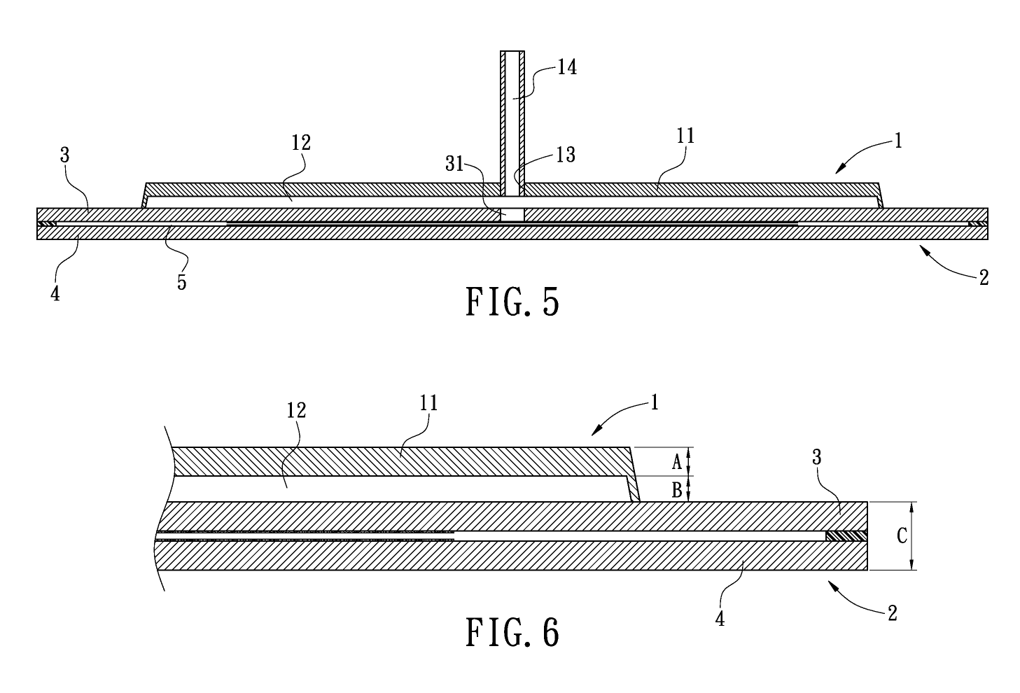

Referring to FIGS. 3 to 5, the vacuum getter structure 1 and the panel 2 are connected together, and vacuum process is performed. Two apertures 31 and 31′ are formed on a non-display effective area located at edges of the cathode plate 3 of the panel 2. Each aperture 31 and 31′ extends through the cathode plate 3 to form channels communicating the getter chamber 12 and a vacuum space 5 between the cathode plate 3 and the anode plate 4.

There are getters 6 distributed between the apertures 31 and 31′ so that the getters 6 are continuously arranged along the vacuum getter structure 1 to be enclosed in the U-shaped getter chamber 12. In this embodiment, barium alloy St22 provided by SAES Company is used as the getter 6 because its activation temperature is about 450° C. In addition, the activated barium alloy will not generate large-area barium powders attached inside the getter chamber 12. The configuration of the barium alloy can be designed according to the getter chamber or other gas collecting/absorbing metal.

The getters 6 are attached to the cathode plate 3 between the holes 31 and 31′ by glass glue. The vacuum getter structure 1 is then attached to the cathode plate 3 to cover the apertures 31 and 31′ and the getters 6. A tube member 14 is installed at the hole 13 of the vacuum getter structure 1 to connect the getter chamber 12 to an external vacuum device. Thereby, a chemical vacuum state can be formed within the vacuum getter structure 1 and the space 5, and a free path is formed between the cathode plate 3 and the anode plate 4, such that an electron beam generated by the cathode plate 3 can propagate along the free path to impinge the phosphor of the anode plate 4 to generate light.

As shown in FIG. 6, when the vacuum getter structure 1 is sealedly attached to panel 2, not only a good gas conduction coefficient is provided by the getter chamber 12 but also the effective elasticity against bending or other deformations of the panel is strengthened by the U-shaped frame 11. The latter characteristic is based on a frame thickness “A” plus a chamber depth “B” being no less than a factor 0.75 of a panel thickness “C”, that is:
(A+B)/C≧0.75

For instance, as the U-shaped frame 11 has a thickness of 2.8 millimeters, the getter chamber 12 has a depth of 2.5 millimeters and the panel 2 has a thickness of 6.6 millimeters, a ratio of total 5.3 millimeters of the frame thickness and the chamber depth with the panel thickness is 0.8 greater than 0.75, which will makes the panel 2 have 5 times of elasticity than conventional panel.

The above embodiment of vacuum getter structure has at least the following advantages:

1. The U-shaped frame of the vacuum getter structure provides gas guide to reduce vacuuming time, so as to reduce the cost.

2. The design of the getter chamber with a depth of only 2.5 millimeters minimizes the effect to overall thickness of the flat panel display.

3. The elongate large-area gas collecting chamber provided by the U-shaped frame resolves the problem of insufficient vacuum level at the corners.

4. The U-shaped frame of the vacuum getter structure is also functioning as structurally reinforcing rib, such that the strength of the cathode plate is enhanced. Therefore, the glass cracking problem caused by local high temperature during tip-off process is overcome.

5. The function matches the long, thin type getter. The number of locations to distribute the getters is reduced. Therefore, the vacuum level can be enhanced. Further, as the depth of the getter chamber is not too much, the thin and light requirement of the flat panel display will not be affected.

6. The getter is only disposed along the side of the cathode plate, and the activation temperature is low, such that the internal material will not be affected, and the available display area is increased.

While the present invention has been particularly shown and described with reference to preferred embodiments thereof, it will be understood by those of ordinary skill in the art the various changes in form and details may be made therein without departing from the spirit and scope of the present invention as defined by the appended claims.

What is claimed is:

1. A flat panel display, comprising:
a panel, having an anode plate and a cathode plate forming a vacuum space therebetween, wherein the cathode plate includes two apertures formed on a non-display effective area located at edges thereof to extend therethough;
a plurality of getters distributed along two edges of the cathode plate between the two apertures; and
a vacuum getter structure including a U-shaped frame recessed upwardly from a bottom surface to form a continuous getter chamber and a hole in communication with the getter chamber, the U-shaped frame being attached to the cathode plate to cover the two apertures and all the getters in the getter chamber,
wherein a thickness of the U-shaped frame plus a depth of the getter chamber are no less than a factor 0.75 of a thickness of the panel.

2. The display of claim 1, further comprising a tube member installed at the hole to connect the getter chamber to an external vacuum device.

3. The display of claim 1, further comprising an electron-emission source formed on a surface of the cathode plate opposite to the surface formed the getters and the apertures.

4. The display of claim 1, further comprising a phosphor layer formed on the anode plate.

5. The display of claim 1, wherein the getter includes a barium alloy.

6. The display of claim 1, wherein the getter includes a barium alloy having an activation temperature about 450° C.

7. The display of claim 1, wherein the getter is attached to the cathode plate by glass glue.

8. The display of claim 1, wherein the U-shaped frame has a thickness of 2.8 millimeters, the getter chamber has a depth of 2.5 millimeters and the panel has a thickness of 6.6 millimeters, so that a ratio of total 5.3 millimeters of the frame thickness and the chamber depth with the panel thickness is 0.8 greater than 0.75.
